(19) United States
(12) Patent Application Publication
(10) Pub. No.: US 2024/0166782 A1
(43) Pub. Date: May 23, 2024

(54) BRØNSTED ACID CATALYST POLYMERIC COMPOSITIONS

(71) Applicant: Dow Global Technologies LLC, Midland, MI (US)

(72) Inventors: Bharat I. Chaudhary, Princeton, NJ (US); Kurt A. Bolz, III, Allentown, NJ (US); Peter C. Dreux, Lumberton, NJ (US); Venkata Krishna Sai Pappu, Manvel, TX (US); Arkady L. Krasovskiy, Lake Jackson, TX (US)

(21) Appl. No.: 18/550,481

(22) PCT Filed: Jun. 6, 2022
(86) PCT No.: PCT/US2022/032374

§ 371 Date: Sep. 14, 2023

Related U.S. Application Data
(63) Continuation of application No. 63/197,626, filed on Jun. 7, 2021.

(51) Int. Cl. C08F 210/02; C08K 3/04; C08L 23/08; C09D 123/08; H01B 3/44

(52) U.S. Cl. CPC C08F 210/02; C08K 3/04; C08L 23/0892; C09D 123/0892; H01B 3/441; H01B 7/295

(57) ABSTRACT

A polymeric composition includes an ethylene-silane copolymer comprising units derived from ethylene monomer and a silane monomer, wherein the ethylene-silane copolymer has a copolymerized silane content from 0.48 mol % to 1.00 mol %, a Brønsted acid catalyst and a filler comprising one or more of a flame retardant and carbon black. A Filler to Catalyst Weight Ratio is from 75 to 1000.

### BACKGROUND

### Field of the Disclosure

The present disclosure relates to polymeric compositions, and more specifically to polymeric compositions comprising Brønsted acid catalysts.

### INTRODUCTION

Ethylene-silane copolymers are used in the formation of moisture-crosslinkable polymer compositions. Such polymeric compositions are used to fabricate wires and cables including low-voltage cable constructions and may be utilized as either a jacket for the cable or as electrical insulation. The silane comonomer that is copolymerized with ethylene to make the ethylene-silane copolymer facilitates the crosslinking of the polymeric composition. The crosslinking of the polymeric composition is often referred to as “curing.” The copolymerized silane content of the copolymer can be adjusted depending on the desired level of curing of the polymeric composition. For example, U.S. Pat. No. 8,460,770 (“the '770 patent”) discloses that an ethylene-silane copolymer can include from 0.5 weight percent to 5 weight percent of silane comonomer.

Polymeric compositions including an ethylene-silane copolymer typically employ a catalyst to speed the curing (crosslinking) of the polymeric composition. One option for the type of catalyst that may be utilized is a condensation cure catalyst. Conventional condensation cure catalysts employed in the polymeric compositions include Lewis acids or Brønsted acids. It is desirable that polymer compositions made with ethylene-silane copolymers cure as fast as possible while under ambient conditions (i.e., 23° C. and 50% relative humidity). For this, Brønsted acids are preferred as they are much more effective than Lewis acids at accelerating cure (crosslinking) in ambient environments. A commonly used measure for how quickly curing occurs is to measure how many days until the polymeric composition reaches a fixed level of hot creep, such as 60% hot creep, when cured at ambient conditions. Hot creep is measured at a specified temperature (either 200° C. or 150° C.) under a fixed stress (e.g., 0.2 MPa) by the test method described ahead, based on Insulated Cable Engineers Association (ICEA) standard for power cable insulation materials, ICEA-T-28-562-2003. Increasing the copolymerized silane content and/or amount of catalyst can decrease the time taken to reach 60% hot creep, but may not be economical or may lead to extrusion processability issues.

Polymeric compositions may include one or more filler materials to alter the properties of the polymeric composition. For example, the filler materials may include flame retardants to make the polymeric composition flame retardant and carbon black to provide ultraviolet (“UV”) resistance properties to the polymeric composition. In polymeric compositions that do not include fillers such as flame retardants and carbon black, Brønsted acid catalysts are known to generate much faster crosslinking under ambient conditions than Lewis acids. However, polymeric compositions comprising a filler exhibit the opposite effect. While Lewis acid catalysts are compatible with flame retardant and carbon black fillers, Brønsted acid catalysts exhibit a sharp deterioration in crosslinking performance with the incorporation of fillers resulting in unacceptably long cure times at ambient conditions. For example, the '770 patent explains that when “filler is present, the filler is coated with a material that will prevent or retard any tendency that the filler might otherwise have to interfere with the silane cure reaction.” However, even if a filler is coated, it is not assured that the coating would necessarily alleviate the problem.

In view of the apparent incompatibility of Brønsted acid catalysts and fillers (especially those that are uncoated), it would be surprising to discover a polymeric composition exhibiting an enhanced cure rate that comprises both filler and a Brønsted acid catalyst.

### SUMMARY OF THE DISCLOSURE

The inventors of the present application have surprisingly discovered a polymeric composition exhibiting an enhanced cure rate at ambient conditions that comprises both a filler and a Brønsted acid catalyst.

The present invention is a result of discovering that utilizing an ethylene-silane copolymer having a copolymerized silane content from 0.48 mol % to 1.00 mol % enables the use of Brønsted acid catalysts and fillers with little or no reduction in cure speed. Surprisingly, employing a Filler to Catalyst Weight Ratio of 75 to 1000 in combination with an ethylene-silane copolymer having a copolymerized silane content from 0.48 mol % to 1.00 mol % results in accelerated cure despite the incorporation of filler. Such a result is advantageous in that it enables shorter ambient condition curing times which reduces costs associated with the curing process while also allowing various additional properties to be imparted on the polymeric composition.

The present invention is particularly useful in the manufacture of wires and cables.

According to a first feature of the present disclosure, a polymeric composition includes an ethylene-silane copolymer comprising units derived from ethylene monomer and a silane monomer, wherein the ethylene-silane copolymer has a copolymerized silane content from 0.48 mol % to 1.00 mol %, a Brønsted acid catalyst and a filler comprising one or more of a flame retardant and carbon black. A Filler to Catalyst Weight Ratio is from 75 to 1000.

According to a second feature of the present disclosure, the filler comprises both flame retardant and carbon black.

According to a third feature of the present disclosure, the Brønsted acid catalyst is a sulfonic acid.

According to a fourth feature of the present disclosure, the Brønsted acid catalyst is an arylsulfonic acid.

According to a fifth feature of the present disclosure, the polymeric composition comprises from 0.01 wt % to 0.50 wt % Brønsted acid catalyst based on the total weight of the polymeric composition.

According to a sixth feature of the present disclosure, the silane is vinyltrimethylsiloxane.

According to a seventh feature of the present disclosure, the copolymerized silane content of the ethylene-silane copolymer is from 0.55 mol % to 0.80 mol %.

According to an eighth feature of the present disclosure, the Filler to Catalyst Weight Ratio is from 100 to 700.

According to a ninth feature of the present disclosure, the Filler to Catalyst Weight Ratio is from 100 to 500.

According to a tenth feature of the present disclosure, a cable comprises a conductor and the polymeric composition of the present disclosure disposed around the conductor.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise indicated. As used herein, a “CAS number” is the chemical services registry number assigned by the Chemical Abstracts Service.

The term “ambient conditions,” as used herein, is an air atmosphere with a temperature from 5° C. to 50° C. and a relative humidity from 5% to 100%.

### Polymeric Composition

The polymeric composition comprises an ethylene-silane copolymer, a Brønsted acid catalyst and a filler. The polymeric composition has a Filler to Catalyst Weight Ratio from 75 to 1000.

### Ethylene-Silane Copolymer

The ethylene-silane copolymer comprises units derived from ethylene monomer and a silane monomer. A “copolymer” means a macromolecular compound prepared by reacting (i.e., polymerizing) monomers of different types. The ethylene-silane copolymer is prepared by the copolymerization of ethylene and a silane monomer.

The polymeric composition may comprise 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, while at the same time, or 98 wt % or less, or 95 wt % or less, or 90 wt % or less, or 85 wt % or less, or 80 wt % or less, or 75 wt % or less, or 70 wt % or less, or 65 wt % or less, or 60 wt % or less, or 55 wt % or less, or 50 wt % or less, or 45 wt % or less of ethylene-silane copolymer based on the total weight of the polymeric composition.

The ethylene-silane copolymer has a density of 0.910 grams per cubic centimeter (“g/cc”) or greater, or 0.915 g/cc or greater, or 0.920 g/cc or greater, or 0.921 g/cc or greater, or 0.922 g/cc or greater, or 0.925 g/cc to 0.930 g/cc or greater, or 0.935 g/cc or greater, while at the same time, 0.940 g/cc or less, or 0.935 g/cc or less, or 0.930 g/cc or less, or 0.925 g/cc or less, or 0.920 g/cc or less, or 0.915 g/cc or less as measured by ASTM D792.

The ethylene-silane copolymer comprises 90 wt % or greater, or 91 wt % or greater, or 92 wt % or greater, or 93 wt % or greater, or 94 wt % or greater, or 95 wt % or greater, or 96 wt % or greater, or 96.5 wt % or greater, or 97 wt % or greater, or 97.5 wt % or greater, or 98 wt % or greater, or 99 wt % or greater, while at the same time, 99.5 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less of α-olefin as measured using Fourier-Transform Infrared (FTIR) Spectroscopy. The α-olefin may include C₂, or C₃ to C₄, or C₆, or C₈, or C₁₀, or C₁₂, or C₁₆, or C₁₈, or C₂₀ α-olefins, such as ethylene, propylene, 1-butene, 1-hexene, 4-methyl-1-pentene, and 1-octene. Other units of the silane-functionalized polyolefin may be derived from one or more polymerizable monomers including, but not limited to, unsaturated esters. The unsaturated esters may be alkyl acrylates, alkyl methacrylates, or vinyl carboxylates. The alkyl groups can have from 1 to 8 carbon atoms, or from 1 to 4 carbon atoms. The carboxylate groups can have from 2 to 8 carbon atoms, or from 2 to 5 carbon atoms. Examples of acrylates and methacrylates include, but are not limited to, ethyl acrylate, methyl acrylate, methyl methacrylate, t-butyl acrylate, n-butyl acrylate, n-butyl methacrylate, and 2-ethylhexyl acrylate. Examples of vinyl carboxylates include, but are not limited to, vinyl acetate, vinyl propionate, and vinyl butanoate.

The ethylene-silane copolymer may comprise 0.48 mol % to 1.00 mol % of copolymerized silane. For example, the ethylene-silane copolymer may comprise 0.48 mol % or greater, or 0.50 mol % or greater, or 0.55 mol % or greater, or 0.60 mol % or greater, or 0.65 mol % or greater, or 0.70 mol % or greater, or 0.75 mol % or greater, or 0.80 mol % or greater, or 0.85 mol % or greater, or 0.90 mol % or greater, or 0.95 mol % or greater, while at the same time, 1.00 mol % or less, or 0.95 mol % or less, or 0.90 mol % or less, or 0.85 mol % or less, or 0.80 mol % or less, or 0.75 mol % or less, or 0.70 mol % or less, or 065 mol % or less, or 0.60 mol % or less, or 0.55 mol % or less, or 0.50 mol % or less of copolymerized silane based on the total moles of ethylene-silane copolymer. The content of copolymerized silane present in the ethylene-silane copolymer is determined through Silane Testing as explained in greater detail below.

The silane comonomer used to make the ethylene-silane copolymer may be a hydrolyzable silane monomer. A “hydrolyzable silane monomer” is a silane-containing monomer that will effectively copolymerize with an α-olefin (e.g., ethylene) to form an α-olefin/silane copolymer (such as an ethylene/silane reactor copolymer). The hydrolyzable silane monomer has structure (I):

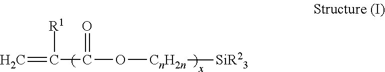

in which R¹ is a hydrogen atom or methyl group; x is 0 or 1; n is an integer from 1 to 4, or 6, or 8, or 10, or 12; and each R² independently is a hydrolyzable organic group such as an alkoxy group having from 1 to 12 carbon atoms (e.g., methoxy, ethoxy, butoxy), an aryloxy group (e.g., phenoxy), an araloxy group (e.g., benzyloxy), an aliphatic acyloxy group having from 1 to 12 carbon atoms (e.g., formyloxy, acetyloxy, propanoyloxy), an amino or substituted amino group (e.g., alkylamino, arylamino), or a lower-alkyl group having 1 to 6 carbon atoms, with the proviso that not more than one of the three R² groups is an alkyl. The hydrolyzable silane monomer may be copolymerized with an α-olefin (such as ethylene) in a reactor, such as a high-pressure process to form an α-olefin-silane reactor copolymer. In examples where the α-olefin is ethylene, such a copolymer is referred to herein as an ethylene-silane copolymer.

The hydrolyzable silane monomer may include silane monomers that comprise an ethylenically unsaturated hydrocarbyl group, such as a vinyl, allyl, isopropenyl, butenyl, cyclohexenyl or gamma (meth)acryloxy allyl group, and a hydrolyzable group, such as, for example, a hydrocarbyloxy, hydrocarbonyloxy, or hydrocarbylamino group. Hydrolyzable groups may include methoxy, ethoxy, formyloxy, acetoxy, proprionyloxy, and alkyl or arylamino groups. In a specific example, the hydrolyzable silane monomer is an unsaturated alkoxy silane, which can be grafted onto the polyolefin or copolymerized in-reactor with an α-olefin (such as ethylene). Examples of hydrolyzable silane monomers include vinyltrimethoxysilane (“VTMS”), vinyltriethoxysilane (“VTES”), vinyltriacetoxysilane, and gamma-(meth)acryloxy propyl trimethoxy silane. In context to Structure (I), for VTMS: x=0; R¹=hydrogen; and R²=methoxy; for VTES: x=0; R¹=hydrogen; and R²=ethoxy; and for vinyltriacetoxysilane: x=0; R¹═H; and R²=acetoxy.

### Ethylene-Based Polymer

The polymeric composition may comprise one or more ethylene-based polymers. As used herein, “ethylene-based” polymers are polymers in which no units are derived from a silane monomer, and in which greater than 50 wt % of the monomers are ethylene though other co-monomers may also be employed. The ethylene-based polymer can include ethylene and one or more C₃-C₂₀ α-olefin comonomers such as propylene, 1-butene, 1 pentene, 4-methyl-1-pentene, 1-hexene, and 1-octene. The ethylene-based polymer can have a unimodal or a multimodal molecular weight distribution and can be used alone or in combination with one or more other types of ethylene-based polymers (e.g., a blend of two or more ethylene-based polymers that differ from one another by monomer composition and content, catalytic method of preparation, molecular weight, molecular weight distributions, densities, etc.). If a blend of ethylene-based polymers is employed, the polymers can be blended by any in-reactor or post-reactor process.

The ethylene-based polymer may comprise 50 wt % or greater, 60 wt % or greater, 70 wt % or greater, 80 wt % or greater, 85 wt % or greater, 90 wt % or greater, or 91 wt % or greater, or 92 wt % or greater, or 93 wt % or greater, or 94 wt % or greater, or 95 wt % or greater, or 96 wt % or greater, or 97 wt % or greater, or 97.5 wt % or greater, or 98 wt % or greater, or 99 wt % or greater, while at the same time, 100 wt % or less, or 99.5 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less, or 90 wt % or less, or 85 wt % or less, or 80 wt % or less, or 70 wt % or less, or 60 wt % or less of ethylene as measured using Nuclear Magnetic Resonance (NMR) or Fourier-Transform Infrared (FTIR) Spectroscopy. Other units of the ethylene-based polymer may include C₃, or C₄, or C₆, or C₈, or C₁₀, or C₁₂, or C₁₆, or C₁₈, or C₂₀ α-olefins, such as propylene, 1-butene, 1-hexene, 4-methyl-1-pentene, and 1-octene.

The polymeric composition may comprise from 0 wt % to 60 wt % of the ethylene-based polymer. For example, the polymeric composition comprises 0 wt % or greater, or 5 wt % or greater, or 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, while at the same time, 60 wt % or less, or 55 wt % or less, or 50 wt % or less, or 45 wt % or less, or 40 wt % or less, or 35 wt % or less, or 30 wt % or less, or 25 wt % or less, or 20 wt % or less, or 15 wt % or less, or 10 wt % or less, or 5 wt % or less of the ethylene-based polymer.

### Filler

The polymeric composition comprises the filler. The filler is a solid that may not melt or decompose at temperatures up to 150° C. The filler includes (but is not limited to) one or more of a flame retardant (e.g., halogenated or halogen-free), antimony trioxide, zinc borate, zinc carbonate, zinc carbonate hydroxide, hydrated zinc borate, zinc phosphate, zinc stannate, zinc hydrostannate, zinc sulfide, zinc oxide, carbon black, an organo-clay, aluminum trihydroxide, magnesium hydroxide, calcium carbonate, hydromagnesite, huntite, hydrotalcite, boehmite, magnesium carbonate, magnesium phosphate, calcium hydroxide, calcium sulfate, silica, talc and combinations thereof. The polymeric composition may comprise a filler content (i.e., the total wt % of all the above noted fillers) of 1 wt % or greater, or 3 wt % or greater, or 5 wt % or greater, or 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, while at the same time, 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less, or 20 wt % or less, or 15 wt % or less, or 10 wt % or less, or 5 wt % or less, or 3 wt % or less based on the total weight of the polymeric composition.

Examples of halogenated flame retardants include, but are not limited to, hexahalodiphenyl ethers, tetrabromobisphenol A bis (2,3-dibromopropyl ether) octahalodiphenyl ethers, decahalodiphenyl ethers, decahalobiphenyl ethanes, 1,2-bis(trihalophenoxy)ethanes, 1,2-bis(pentahalophenoxy)ethanes, hexahalocyclododecane, a tetrahalobisphenol-A, ethylene(N,N′)-bis-tetrahalophthalimides, tetrahalophthalic anhydrides, hexahalobenzenes, halogenated indanes, halogenated phosphate esters, halogenated paraffins, halogenated polymers, halogenated polystyrenes, and polymers of halogenated bisphenol-A and epichlorohydrin, or mixtures thereof. Particularly desirable halogenated flame retardants are brominated aromatic compounds having bromine contents greater than 50 weight percent, or greater than 60 weight percent, or greater than 70 weight percent. In a highly useful embodiment, the halogenated flame retardant is decabromodiphenyl ether or decabromodiphenyl ethane or ethylene bis-tetrabromophthalimide. Examples of halogen-free flame retardants include, but are not limited to, metal hydrates, metal carbonates, red phosphorous, silica, alumina, aluminum hydroxide, magnesium hydroxide, titanium oxide, carbon nanotubes, talc, clay, organo-modified clay, calcium carbonate, wollastonite, mica, ammonium octamolybdate, frits, hollow glass microspheres, intumescent compounds, expanded graphite, and combinations thereof.

### Brønsted Acid Catalyst

The polymeric composition comprises a Brønsted acid catalyst. A Brønsted acid catalyst includes any acid which is a molecule or ion that is able to lose, or “donate” a hydrogen cation (proton, H⁺). The Brønsted acid catalyst may have a pKa of 6 or less. Exemplary Brønsted acid catalysts include sulfonic acids, carboxylic acid, and phosphoric acid. The sulfonic acid may be an alkylsulfonic acid, an arylsulfonic acid, an alkylarylsulfonic acid, or an arylalkylsulfonic acid. The sulfonic acid may be of formula RSO₃H wherein R is (C₁-C₁₀)alkyl, (C₆-C₁₀)aryl, a (C₁-C₁₀)alkyl-substituted (C₆-C₁₀)aryl, or a (C₆-C₁₀)aryl-substituted (C₁-C₁₀)alkyl. The sulfonic acid may be a hydrophobic sulfonic acid, which may be a sulfonic acid having a solubility in pH 7.0 distilled water of from 0 to less than 0.1 g/mL at 23° C. after 24 hours. Exemplary sulfonic acids include an alkylbenzenesulfonic acid (e.g., 4-methylbenzenesulfonic acid, dodecylbenzenesulfonic acid, or a dialkylbenzenesulfonic acid), naphthalenesulfonic acid, an alkylnaphthalenesulfonic acid, dinonylnapthalene disulfonic acid, methanesulfonic acid, and benzenesulfonic acid. The sulfonic acid may consist of carbon atoms, hydrogen atoms, one sulfur atom, and three oxygen atoms. In an embodiment, the sulfonic acid may be a blocked sulfonic acid, as defined in US 2016/0251535 A1, which is a compound that generates in situ the sulfonic acid of formula RSO₃H wherein R is as defined above upon heating thereof, optionally in the presence of moisture or an alcohol. Examples of the blocked sulfonic acid include amine-sulfonic acid salts and sulfonic acid alkyl esters. The blocked sulfonic acid may consist of carbon atoms, hydrogen atoms, one sulfur atom, and three oxygen atoms, and optionally a nitrogen atom. Exemplary carboxylic acids include benzoic acid and formic acid. Exemplary acid catalysts are available from King Industries Specialty Chemicals under the tradename NACURE™ Acid Catalyst. Commercial examples of such acid catalysts include NACURE™ 155 Sulfonic Acid Catalyst, NACURE™ 1051 Sulfonic Acid Catalyst, NACURE™ CD-2120 Hydrophobic Sulfonic Acid Catalyst and NACURE™ CD-2180 Hydrophobic Sulfonic Acid Catalyst. Furthermore, the NACURE™ materials (all products of King Industries) disclosed in US Patent Application Publication No. 2011/0171570 are examples of blocked sulfonic acids with varying dissociation temperatures. Examples of commercially available blocked sulfonic acids include NACURE™ 1419 (product of King Industries), which is a 30% solution of covalently-blocked dinonylnaphthalenesulfonic acid in xylene/4-methyl-2-pentanone, and NACURE™ 5414 (product of King Industries), which is a 25% solution of covalently-blocked dodecylbenzenesulfonic acid in xylene.

The Brønsted acid catalyst is typically added to the polymeric composition in an extruder (such as during cable manufacture) so that it is present during the final melt extrusion process. As such, the polymeric composition may experience some crosslinking before it leaves the extruder with the completion of the crosslinking after it has left the extruder, typically upon exposure to moisture (e.g., a sauna, hot water bath or a cooling bath) and/or the humidity present in the environment in which it is stored, transported or used.

The Brønsted acid catalyst may be included in a catalyst masterbatch blend with the catalyst masterbatch being included in the composition. Nonlimiting examples of suitable catalyst masterbatches include those sold under the trade name SI-LINK™ from The Dow Chemical Company, including SI-LINK™ AC DFDA-5488 NT and SI-LINK™ AC DFDB-5418 BK.

The polymeric composition comprises the Brønsted acid catalyst in an amount of 0.01 wt % or greater, or 0.02 wt % or greater, or 0.04 wt % or greater, or 0.06 wt % or greater, or 0.08 wt % or greater, or 0.10 wt % or greater, or 0.12 wt % or greater, or 0.14 wt % or greater, or 0.16 wt % or greater, or 0.18 wt % or greater, or 0.20 wt % or greater, or 0.22 wt % or greater, or 0.24 wt % or greater, or 0.26 wt % or greater, or 0.28 wt % or greater, while at the same time 1.0 wt % or less, or 0.80 wt % or less, or 0.60 wt % or less, or 0.50 wt % or less, or 0.40 wt % or less, or 0.30 wt % or less, or 0.28 wt % or less, or 0.26 wt % or less, or 0.24 wt % or less, or 0.22 wt % or less, or 0.20 wt % or less, or 0.18 wt % or less, or 0.16 wt % or less, or 0.14 wt % or less, or 0.12 wt % or less, or 0.10 wt % or less, or 0.08 wt % or less, or 0.06 wt % or less, or 0.04 wt % or less, or 0.02 wt % or less based on the total weight of the polymeric composition.

### Filler to Catalyst Weight Ratio

The polymeric composition has a Filler to Catalyst Weight Ratio of 75 to 1000. The Filler to Catalyst Weight Ratio is calculated by dividing the total wt % of all the combined fillers present in the polymeric composition by the total wt % of Brønsted acid catalyst in the polymeric composition. The Filler to Catalyst Weight Ratio is 75 or greater, or 100 or greater, or 150 or greater, or 200 or greater, or 250 or greater, or 300 or greater, or 350 or greater, or 400 or greater, or 450 or greater, or 500 or greater, or 550 or greater, or 600 or greater, or 650 or greater, or 700 or greater, or 750 or greater, or 800 or greater, or 850 or greater, or 900 or greater, or 950 or greater, while at the same time, 1000 or less, or 950 or less, or 900 or less, or 850 or less, or 800 or less, or 750 or less, or 700 or less, or 650 or less, or 600 or less, or 550 or less, or 500 or less, or 450 or less, or 400 or less, or 350 or less, or 300 or less, or 250 or less, or 200 or less, or 150 or less, or 100 or less.

### Additives

The polymeric composition may include one or more additives. Nonlimiting examples of suitable additives include antioxidants, moisture scavengers (including hydrolyzable silane monomers), colorants (other than carbon black, which is already included as Filler), corrosion inhibitors, lubricants, ultraviolet (UV) absorbers or stabilizers, anti-blocking agents, compatibilizers, plasticizers, processing aids, and combinations thereof.

The polymeric composition may include an antioxidant. Nonlimiting examples of suitable antioxidants include phenolic antioxidants, thio-based antioxidants, phosphate-based antioxidants, and hydrazine-based metal deactivators. Suitable phenolic antioxidants include high molecular weight hindered phenols, methyl-substituted phenol, phenols having substituents with primary or secondary carbonyls, and multifunctional phenols such as sulfur and phosphorous-containing phenol. Representative hindered phenols include 1,3,5-trimethyl-2,4,6-tris-(3,5-di-tert-butyl-4-hydroxybenzyl)-benzene; pentaerythrityl tetrakis-3(3,5-di-tert-butyl-4-hydroxyphenyl)-propionate; n-octadecyl-3(3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; and sorbitol hexa[3-(3,5-di-tert-butyl-4-hydroxy-phenyl)-propionate]. In an embodiment, the composition includes pentaerythritol tetrakis(3-(3,5-di-tert-butyl-4-hydroxyphenyl)propionate), commercially available as Irganox™ 1010 from BASF. A nonlimiting example of a suitable methyl-substituted phenol is isobutylidenebis(4,6-dimethylphenol). A nonlimiting example of a suitable hydrazine-based metal deactivator is oxalyl bis(benzylidiene hydrazide). In an embodiment, the composition contains from 0 wt %, or 0.001 wt %, or 0.01 wt %, or 0.02 wt %, or 0.05 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt % antioxidant, based on total weight of the composition.

The polymeric composition may include an ultraviolet (UV) absorber or stabilizer. A nonlimiting example of a suitable UV stabilizer is a hindered amine light stabilizer (HALS). A nonlimiting example of a suitable HALS is 1,3,5-Triazine-2,4,6-triamine, N,N-1,2-ethanediylbisN-3-4,6-bisbutyl(1,2,2,6,6-pentamethyl-4-piperidinyl)amino-1,3,5-triazin-2-ylaminopropyl-N,N-dibutyl-N,N-bis(1,2,2,6,6-pentamethyl-4-piperidinyl)-1,5,8,12-tetrakis[4,6-bis(n-butyl-n-1,2,2,6,6-pentamethyl-4-piperidylamino)-1,3,5-triazin-2-yl]-1,5,8,12-tetraazadodecane, which is commercially available as SABO™ STAB UV-119 from SABO S.p.A. of Levate, Italy. In an embodiment, the composition contains from 0 wt %, or 0.001 wt %, or 0.002 wt %, or 0.005 wt %, or 0.006 wt % to 0.007 wt %, or 0.008 wt %, or 0.009 wt %, or 0.01 wt %, or 0.2 wt %, or 0.3 wt %, or 0.4 wt %, or 0.5 wt %, 1.0 wt %, or 2.0 wt %, or 2.5 wt %, or 3.0 wt % UV absorber or stabilizer, based on total weight of the polymeric composition.

The polymeric composition may include a processing aid. Nonlimiting examples of suitable processing aids include oils, polydimethylsiloxane, organic acids (such as stearic acid), and metal salts of organic acids (such as zinc stearate). In an embodiment, the polymeric composition contains from 0 wt %, or 0.01 wt %, or 0.02 wt %, or 0.05 wt %, or 0.07 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt %, or 5.0 wt %, or 10.0 wt % processing aid, based on total weight of the polymeric composition.

In an embodiment, the polymeric composition contains 0 wt %, or greater than 0 wt %, or 0.001 wt %, or 0.002 wt %, or 0.005 wt %, or 0.006 wt % to 0.007 wt %, or 0.008 wt %, or 0.009 wt %, or 0.01 wt %, or 0.2 wt %, or 0.3 wt %, or 0.4 wt %, or 0.5 wt %, 1.0 wt %, or 2.0 wt %, or 2.5 wt %, or 3.0 wt %, or 4.0 wt %, or 5.0 wt % to 6.0 wt %, or 7.0 wt %, or 8.0 wt %, or 9.0 wt %, or 10.0 wt %, or 15.0 wt %, or 20.0 wt %, or 30 wt %, or 40 wt %, or 50 wt % of the additive based on the total weight of the polymeric composition.

One or more of the components or masterbatches may be dried before compounding or extrusion, or a mixture of components or masterbatches is dried after compounding or extrusion, to reduce or eliminate potential scorch that may be caused from moisture present in or associated with the component, e.g., filler. The compositions may be prepared in the absence of a catalyst for extended shelf life, and the catalyst may be added as a final step in the preparation of a cable construction by extrusion processes. Alternatively, the catalyst may be combined with one or more other components in the form of a masterbatch.

### Coated Conductor

The present disclosure also provides a coated conductor. The coated conductor includes a conductor and a coating on the conductor, the coating including the polymeric composition. The polymeric composition is at least partially disposed around the conductor to produce the coated conductor.

The process for producing a coated conductor includes mixing and heating the polymeric composition to at least the melting temperature of the ethylene-silane copolymer in an extruder, and then coating the polymeric melt blend onto the conductor. The term “onto” includes direct contact or indirect contact between the polymeric melt blend and the conductor. The polymeric melt blend is in an extrudable state.

The polymeric composition is disposed around on and/or around the conductor to form a coating. The coating may be one or more inner layers such as an insulation layer. The coating may wholly or partially cover or otherwise surround or encase the conductor. The coating may be the sole component surrounding the conductor. Alternatively, the coating may be one layer of a multilayer jacket or sheath encasing the metal conductor. The coating may directly contact the conductor. The coating may directly contact an insulation layer surrounding the conductor.

The resulting coated conductor (cable) is cured at humid conditions for a sufficient length of time such that the coating reaches a desired degree of crosslinking. The temperature during cure is generally above 0° C. In an embodiment, the cable is cured (aged) for at least 4 hours in a 90° C. water bath. In an embodiment, the cable is cured (aged) for up to 30 days at ambient conditions comprising an air atmosphere, Ambient Conditions as defined above.

In an embodiment, the polymeric composition is coated at 0.762 mm thickness onto a 14 AWG conductor (diameter: 1.63 mm) and attains 60% hot creep within 14 days or less (or 12 days or less, or 10 days or less, or 8 days or less, or 7 days or less, or 6 days or less, or 5 days or less, or 4 days or less, or 3 days or less, or 2 days or less, or 1 day or less), when the coated conductor is cured at ambient conditions of 23° C. and 50% relative humidity.

### Examples

### Test Methods

Density: Density is measured in accordance with ASTM D792, Method B. The result is recorded in g/cc.

Melt Index: Melt index (MI) is measured in accordance with ASTM D1238, Condition 190° C./2.16 kilogram (kg) weight and is reported in grams eluted per 10 minutes (g/10 min).

Silane Testing: Use x-ray fluorescence spectroscopy (“XRF”) to determine weight percent (wt %) of silicon atom (Si) content of, and then calculate silane comonomeric unit wt % in, test samples of the ethylene-silane copolymer. Using a Buehler SimpliMet 300 automatic mounting press that is preheated for 3 minutes at 115.6° C. (240 degrees Fahrenheit (° F.)), press a powdered form of test sample for 1 minute under 8.3 megapascals (MPa; 1,200 pounds per square inch (psi)) to form a plaque having a thickness of about 6 mm, and cool the plaque to 25° C. Analyze the Si atom content of the plaque by wavelength dispersive XRF using a wavelength dispersive X-ray fluorescence spectrometer from PANalytical Axios. Determine Si atom content by comparing its line intensity in the XRF spectrum to a calibration curve for Si atom content that is established using polymer standards of known Si atom concentrations as independently measured using Neutron Activation Analysis (NAA) or Inductively Coupled Plasma (ICP) methods. Use the XRF measured Si atom wt % value, and the molecular weight(s) of the at least one silane comonomer from which the hydrolyzable silyl groups were derived, to calculate hydrolyzable silyl group comonomeric unit wt % (i.e., wt % of the hydrolyzable silyl groups) in the ethylene-silane copolymer. For hydrolyzable silyl groups derived from vinyltrimethoxysilane (VTMS), use the VTMS molecular weight of 148.23 g/mol. To calculate hydrolyzable silyl group content of (wt % of hydrolyzable silyl group comonomeric units in) the ethylene-silane copolymer, use the XRF obtained Si atom wt % (“C”) and the following formula: p=C*(m/28.086)( 1/10000 ppmw), wherein * means multiplication, / means division, p is wt % hydrolyzable silyl groups in ethylene-silane copolymer, C is the Si atom amount (XFR) in weight parts per million (ppmw), m is the molecular weight in g/mol of the silane comonomer from which the hydrolysable silyl groups are derived, 28.086 is the atomic weight of a silicon atom, and 10000 ppmw is the number of weight parts per million in 1.00 wt %. For example, when XRF shows 379 ppmw of Si atom in ethylene-silane copolymer and the comonomer used to make the ethylene-silane copolymer is VTMS having a molecular weight of 148.23 g/mol, the wt % comonomeric content is 0.20 wt %. To calculate mol % of hydrolyzable silyl group comonomeric units in the ethylene-silane copolymer of the silane comonomer used, use the calculated wt % of the hydrolyzable silyl group comonomeric units in ethylene-silane copolymer and the following equation: G=100*(p/m)/[(p/m)+(100.00 wt %−p)/28.05 g/mol], wherein * means multiplication, G is mole percent (mol %) of hydrolyzable silyl groups in the ethylene-silane copolymer; p is wt % of hydrolyzable silyl groups in ethylene-silane copolymer, m is molecular weight in g/mol of the silane comonomer from which the hydrolyzable silyl groups are derived, and 28.05 g/mol is the molecular weight of monomer ethylene (H₂C═CH₂). For example, when comonomeric content is 2.0 wt % and the comonomer is VTMS, p=2.0 wt % and m=148.23 g/mol, and G=0.38 mol %. When comonomeric content is 5.0 wt % and the comonomer is VTMS, p=5.0 wt % and m=148.23 g/mol, and G=0.99 mol %. When two or more silane comonomers having different molecular weights are used to make ethylene-silane copolymer, the molecular weight used in the calculation of the total mol % of all hydrolyzable silyl groups in ethylene-silane copolymer is a weighted average molecular weight of the comonomers. The weighting may be determined by the proportion of the amounts of the comonomers fed into the reactor; alternatively by NMR spectroscopy on the ethylene-silane copolymer to determine the relative amounts of the different comonomeric units in the ethylene-silane copolymer when the respective hydrolyzable silyl groups are bonded to different types of carbon atoms (e.g., tertiary versus secondary carbon atoms); alternatively by Fourier Transform Infrared (FT-IR) spectroscopy calibrated to provide quantitation of the different types comonomers.

Hot Creep Test Method: Measures extent of crosslinking, and thus extent of curing, in test samples of the polymeric composition prepared by the Moisture Curing Method outlined below. Testing is based on the Insulated Cable Engineers Association (ICEA) standard for power cable insulation materials, ICEA-T-28-562-2003. Specimens are taken out along the extrusion direction from a coated conductor having insulation layer of thickness value ranging from 0.736 to 3.048 mm (29 to 120 mils). Subject test samples to Hot Creep Test Method under a load, Wt, and at 200° C., according to UL 2556, Wire and Cable Test Methods, Section 7.9. Load Wt=CA*200 kilopascals (kPa, 29.0 pound-feet per square inch), wherein CA is the cross-sectional area of the insulation layer specimen cut from a coated conductor sample prepared according to the Coated Conductor Preparation Method. Prepare three specimens per test material. Make two marks on the specimen at an original distance H apart from each other, wherein H=25+/−2 mm. Place in upper grip of hot creep test assembly. Hang load 0.2 megapascals (MPa) from gripped specimen. Heat the test assembly with specimen in a preheated circulating air oven at 200° C.+/−2° C. or 150° C.+/−2° C. for 15 minutes, and then with the load still attached measure the specimen's final length Dₑ between the marks. Calculate hot creep elongation percent (HCE) according to equation 1: HCE [100*(Dₑ−H)]/H (1). The amount of extension divided by initial length provides a measure of hot creep as a percentage. The lower the HCE (also referred to as “hot creep”), the lower the extent of elongation of a test specimen under load, and thus the greater the extent of crosslinking, and thus the greater the extent of curing. A lower hot creep value indicates a higher crosslink degree.

### Materials

The materials used in the examples are provided below.

ESC1 is an ethylene-silane copolymer containing a moisture scavenger and characterized by melt index (I2) of 1.5 g/10 minutes, a density 0.921 g/cc, a copolymerized VTMS content of 0.31 mol % and a crystallinity at 23° C. of 46.8 wt %. ESC1 is available from The Dow Chemical Company, Midland, Michigan.

ESC2 is an ethylene-silane copolymer characterized by a melt index (I2) of 2.0 g/10 minutes, density 0.922 g/cc, a copolymerized VTMS content of 0.65 mol %, and a crystallinity at 23° C. of 44.6 wt %. ESC2 is available from The Dow Chemical Company, Midland, Michigan.

FRMB is a flame retardant masterbatch that is a blend of a thermoplastic ethylenic polymer, an antioxidant, a hindered amine stabilizer, and about 60 wt % filler (brominated flame retardant and antimony trioxide). FRMB is available from The Dow Chemical Company, Midland, Michigan.

CBMB is a carbon black masterbatch comprising a blend of a thermoplastic ethylenic polymer, an antioxidant, and about 40 wt % of carbon black (filler). CBMB is available from The Dow Chemical Company, Midland, Michigan.

CAMB is a catalyst masterbatch comprising a blend of thermoplastic ethylenic polymers, an antioxidant, and about 3 wt % of an arylsulfonic acid. CAMB is available from The Dow Chemical Company, Midland, Michigan.

CCMB is a combined catalyst and carbon black masterbatch comprising a blend of thermoplastic ethylenic polymer, a moisture scavenger, an antioxidant, a stabilizer, about 31 wt % carbon black (filler), and about 1.5 wt % of an arylsulfonic acid. CCMB is available from The Dow Chemical Company, Midland, Michigan.

### Coated Conductor Preparation Method

Samples of inventive examples (“IE”) 1 and 2 and comparative examples (“CE”) 1-4 were prepared by mixing pellets of the components of Table 1 in a fiber drum. Next, the samples were melt-mixed during extrusion to make coated conductors having a 0.762 mm thick coating of the polymeric composition on a 14 American wire gauge solid copper conductor (“wire”). The coated conductors were fabricated using a 63.5 mm Davis Standard extruder with a double-flighted Maddock screw and 20/40/60/20 mesh screens, at the following set temperatures (° C.) across zone 1/zone 2/zone 3/zone 4/zone 5/head/die: 129.4/135.0/143.3/148.9/151.7/165.6/165.6. The length-to-diameter (L/D) ratio of the screw was 26 (measured from the beginning of the screw flight to the screw tip) or 24 (measured from the screw location corresponding to the end of the feed casing to the screw tip). The coated conductors were fabricated at a line speed of 91.44 meters per minute, using the following screw speeds: 38 revolutions per minute (“rpm”) for IE1 and CE1; 37 rpm for IE2 and CE2; and 39 rpm for CE3 and CE4.

### Moisture Curing Method

The coated conductors were aged at 23° C. and 50% relative humidity (RH) and hot creep measurements according to the Hot Creep Test Method were conducted after various time intervals to compute the number of days required to attain 60% hot creep at ambient conditions.

### Results

Table 1 provides both the composition and the curing performance of IE1, IE2 and CE1-CE4.

TABLE 1

| Composition | | | | | | |
|---|---|---|---|---|---|---|
| (wt %) | IE1 | CE1 | IE2 | CE2 | CE3 | CE4 |
| ESC1 (wt %) | | 63.7 | | 67.0 | | 95.0 |
| ESC2 (wt %) | 65.7 | | 67.0 | | 95.0 | |
| FRMB (wt %) | 25.0 | 25.0 | 25.0 | 25.0 | | |
| CBMB (wt %) | 6.3 | 6.3 | | | | |
| CAMB (wt %) | 3.0 | 5.0 | | | 5.0 | 5.0 |
| CCMB (wt %) | | | 8.0 | 8.0 | | |
| Brønsted Acid | 0.08 | 0.14 | 0.12 | 0.12 | 0.14 | 0.14 |
| (wt %) | | | | | | |
| Flame Retardant | 15.00 | 15.00 | 15.00 | 15.00 | 0.00 | 0.00 |
| (wt %) | | | | | | |
| Carbon Black | 2.52 | 2.52 | 2.50 | 2.50 | 0.00 | 0.00 |
| Total Filler | 17.52 | 17.52 | 17.5 | 17.50 | 0.00 | 0.00 |
| Amount | | | | | | |
| Filler to Catalyst | 219 | 125 | 146 | 146 | 0 | 0 |
| Weight Ratio | | | | | | |
| Days Required | 3 | 20 | 4 | >140* | 1.5 | 6 |
| to Attain 60% | | | | | | |
| Hot Creep at | | | | | | |
| Ambient | | | | | | |
| Conditions | | | | | | |

*After 140 days at ambient conditions, CE2 had only attained hot creep of 69%.

As evident from Table 1, IE1 and IE2 comprising an ethylene-silane copolymer having a copolymerized silane content from 0.48 mol % to 1.00 mol % and a Filler to Catalyst Weight Ratio from 75 to 1000 demonstrate faster curing at ambient conditions than comparative examples not including this combination of features. For example, IE1 cured about 7 times faster than CE1. Such a result is surprising because IE1 reaches 60% hot creep faster than CE1 despite IE1 containing less Brønsted acid catalyst than CE1. Similarly, IE2 cured more than 35 times faster than CE2 despite equivalent loadings of Brønsted acid catalyst. A comparison of CE3 and CE4 demonstrates that while higher copolymerized silane content affects curing speed, it is not the only factor affecting the curing performance. For example, while the higher silane content of ESC2 (CE3) resulted in a 4 times faster curing than ESC1 (CE4), this performance enhancement falls far short of the 7 times and more than 35 times faster curing rates obtained by IE1 and IE2 relative to CE1 and CE2, respectively. As such, the combination of both copolymerized silane content and the Filler to Catalyst Weight Ratio also are enabling features that affect cure rate. Comparing CE1 with CE4, it can be seen that the inclusion of fillers had deleterious effect on the ambient cure characteristics with ESC1. The same deleterious effect is evident with CE2, and to a greater extent. In contrast, the same fillers appear to have had little or no adverse effect on the crosslinking characteristics when the polymeric composition is made with an ethylene-silane copolymer having a copolymerized silane content from 0.48 mol % to 1.00 mol % and a Filler to Catalyst Weight Ratio from 75 to 1000 (i.e., IE1 and IE2).

1. A polymeric composition, comprising:
an ethylene-silane copolymer comprising units derived from ethylene monomer and a silane monomer, wherein the ethylene-silane copolymer has a copolymerized silane content from 0.48 mol % to 1.00 mol %;
a Brønsted acid catalyst; and
a filler comprising one or more of a flame retardant and carbon black,
wherein a Filler to Catalyst Weight Ratio is from 75 to 1000.

2. The polymeric composition of claim 1, wherein the filler comprises both flame retardant and carbon black.

3. The polymeric composition of claim 1, wherein the Brønsted acid catalyst is a sulfonic acid.

4. The polymeric composition of claim 3, wherein the Brønsted acid catalyst is an arylsulfonic acid.

5. The polymeric composition of claim 1, wherein the polymeric composition comprises from 0.01 wt % to 0.50 wt % Brønsted acid catalyst based on the total weight of the polymeric composition.

6. The polymeric composition of claim 1, wherein the silane is vinyltrimethylsiloxane.

7. The polymeric composition of claim 6, wherein the copolymerized silane content of the ethylene-silane copolymer is from 0.55 mol % to 0.80 mol %.

8. The polymeric composition of claim 1, wherein the Filler to Catalyst Weight Ratio is from 100 to 700.

9. The polymeric composition of claim 9, wherein the Filler to Catalyst Weight Ratio is from 100 to 500.

10. A cable comprising:
a conductor; and
the polymeric composition of claim 1 disposed around the conductor.
